(19) United States
(12) Patent Application Publication
(10) Pub. No.: US 2025/0068303 A1
(43) Pub. Date: Feb. 27, 2025

(54) INFORMATION FEEDBACK METHOD, COMPUTER DEVICE AND STORAGE MEDIUM

(71) Applicant: Beijing Zitiao Network Technology Co., Ltd., Beijing (CN)

(72) Inventor: Yanjun ZHANG, Beijing (CN)

(21) Appl. No.: 18/793,726

(22) Filed: Aug. 2, 2024

(30) Foreign Application Priority Data
Aug. 25, 2023 (CN) 202311085036.X

(51) Int. Cl. G06F 3/0483; G10L 15/18

(52) U.S. Cl. CPC G06F 3/0483; G10L 15/1815

(57) ABSTRACT

Embodiments of the present disclosure provide an information feedback method and apparatus, a computer device and a storage medium. The method includes in response to enabling an information feedback function in a scene of reading a target book, receiving user voice data, and determining an operation intention towards the target book based on a semantic analysis result of the user voice data, wherein the operation intention includes at least one selected from a group consisting of a questioning intention and a control intention; and determining target information for feedback based on book information of the target book and determined operation intention.

This application claims the priority of Chinese Patent Application No. 202311085036.X filed on Aug. 25, 2023, the disclosure of which is incorporated by reference herein in its entirety as part of the present application.

### TECHNICAL FIELD

The present disclosure relates to the technical field of information processing, in particular to an information feedback method and apparatus, a computer device and a storage medium.

### BACKGROUND

In the scene of book reading, readers may have various reading needs, such as wanting to preview upcoming plot developments or refer to specific passages. In some instances, book reading platforms only provide reading tools, when users have specific reading requirements, they need to manually search through the books to access the content they are looking for, which is a cumbersome and inconvenient process.

### SUMMARY

Embodiments of the present disclosure provide an information feedback method and apparatus, a computer device and a storage medium.

In the first aspect, embodiments of the present disclosure provide an information feedback method, which includes: in response to enabling an information feedback function in a scene of reading a target book, receiving user voice data, and determining an operation intention towards the target book based on a semantic analysis result of the user voice data, in which the operation intention comprises at least one selected from a group consisting of a questioning intention and a control intention; and determining target information for feedback based on book information of the target book and determined operation intention.

In an optional implementation, in response to the operation intention towards the target book comprising the questioning intention, the determining target information for feedback based on book information of the target book and determined operation intention includes: determining questioning information for the book information under the questioning intention; and determining response information under the questioning information based on the book information of the target book, as the target information for feedback.

In an optional implementation, the determining response information under the questioning information based on the book information of the target book includes: determining a pre-trained model matching the target book, wherein the pre-trained model is obtained by training based on the book information of the target book; and taking the questioning information as input data of the pre-trained model, making the pre-trained model conduct processing based on the questioning information to obtain an output result, and determining the response information based on the output result.

In an optional implementation, after displaying the response information as the target information, the method further includes: displaying an interactive confirmation pop-up window for the target information, in which the interactive confirmation pop-up window is used for receiving feedback on the target information; in response to the feedback indicating correction of the target information, acquiring a correction result for the target information, and determining the correction result and corresponding questioning information as first tag data; or, in response to the feedback indicating approval of the target information, determining the target information and corresponding questioning information as second tag data; and iteratively updating the pre-trained model by using the first tag data or the second tag data.

In an optional implementation, in response to the operation intention towards the target book comprising the control intention, the determining target information for feedback based on book information of the target book and determined operation intention includes: determining an information type to be changed and a changed target state for the target book under the control intention; and determining display information of various information types under the target state, as the target information for feedback.

In an optional implementation, in response to enabling the information feedback function in the scene of reading the target book, the method further includes: determining an information feedback strategy, wherein the information feedback strategy is determined based on a current reading progress of the target book and/or an information feedback record associated with book information indicated by the current reading progress; and determining reference content information under the information feedback strategy, to determine target information for feedback based on the reference content information, wherein the reference content information comprises the information feedback record, and/or target book information determined from the target book based on the current reading progress.

In an optional implementation, the method further includes: in response to enabling the information feedback function in a non-reading scene, determining that target books in the non-reading scene comprise recommended books and/or previously read books; receiving user voice data, screening out a target book for determining target information from a plurality of books based on a semantic analysis result of the user voice data, and selecting target book information from book information of the target book; and organizing the target book information to obtain the target information for feedback.

In an optional implementation, in response to the semantic analysis result indicating book recommendation, the screened-out target book includes the recommended books and the previously read books, and the target book information includes book types of the recommended books, book types of the previously read books and access-authorized reading records; and organizing the target book information to obtain the target information for feedback includes: based on the access-authorized reading records corresponding to the previously read books, screening out target previously read books with corresponding reading records meeting a screening condition from the previously read books; determining a target book type based on book types corresponding to the target previously read books; and selecting a target recommended book with the target book type from the recommended books, and determining the target information for feedback based on book information corresponding to the target recommended book.

In the second aspect, embodiments of the present disclosure further provide an information feedback apparatus, which includes a receiving module and a determining module. The receiving module is configured to, in response to enabling an information feedback function in a scene of reading a target book, receiving user voice data, and determining an operation intention towards the target book based on a semantic analysis result of the user voice data, in which the operation intention includes at least one selected from a group consisting of a questioning intention and a control intention. The determining module 42 is configured to determine target information for feedback based on book information of the target book and determined operation intention.

In an optional implementation, in response to the operation intention towards the target book including the questioning intention, when the determining module is configured to determine target information for feedback based on book information of the target book and determined operation intention, the determining module is specifically configured to determine questioning information for the book information under the questioning intention; and determine response information under the questioning information based on the book information of the target book, as the target information for feedback.

In an optional implementation, when the determining module is configured to determine response information under the questioning information based on the book information of the target book, the determining module is specifically configured to determine a pre-trained model matching the target book, in which the pre-trained model is obtained by training based on the book information of the target book; and take the questioning information as input data of the pre-trained model, make the pre-trained model conduct processing based on the questioning information to obtain an output result, and determine the response information based on the output result.

In an optional implementation, after displaying the response information as the target information, the determining module is further configured to display an interactive confirmation pop-up window for the target information, in which the interactive confirmation pop-up window is used for receiving feedback on the target information; in response to the feedback indicating correction of the target information, acquire a correction result for the target information, and determine the correction result and corresponding questioning information as first tag data; or, in response to the feedback indicating approval of the target information, determine the target information and corresponding questioning information as second tag data; and iteratively update the pre-trained model by using the first tag data or the second tag data.

In an optional implementation, in response to the operation intention towards the target book including the control intention, when the determining module is configured to determine target information for feedback based on book information of the target book and determined operation intention, the determining module is specifically configured to determine an information type to be changed and a changed target state for the target book under the control intention; and determine display information of various information types under the target state, as the target information for feedback.

In an optional implementation, in response to enabling the information feedback function in the scene of reading the target book, the receiving module is further configured to determine an information feedback strategy, in which the information feedback strategy is determined based on a current reading progress of the target book and/or an information feedback record associated with book information indicated by the current reading progress; and determine reference content information under the information feedback strategy, to determine target information for feedback based on the reference content information, in which the reference content information includes the information feedback record, and/or target book information determined from the target book based on the current reading progress.

In an optional implementation, the apparatus further includes a processing module, the processing module is configured to, in response to enabling the information feedback function in a non-reading scene, determine that target books in the non-reading scene comprise recommended books and/or previously read books; receive user voice data, screening out a target book for determining target information from a plurality of books based on a semantic analysis result of the user voice data, and select target book information from book information of the target book; and organize the target book information to obtain the target information for feedback.

In an optional implementation, in response to the semantic analysis result indicating book recommendation, the screened-out target book includes the recommended books and the previously read books, and the target book information comprises book types of the recommended books, book types of the previously read books and access-authorized reading records; and when the processing module is configured to organize the target book information to obtain the target information for feedback, the processing module is specifically configured to, based on the access-authorized reading records corresponding to the previously read books, screen out target previously read books with corresponding reading records meeting a screening condition from the previously read books; determine a target book type based on book types corresponding to the target previously read books; and select a target recommended book with the target book type from the recommended books, and determine the target information for feedback based on book information corresponding to the target recommended book.

In the third aspect, embodiments of the present disclosure further provide a computer device, which includes a processor and a memory, the memory stores computer-readable instructions executable by the processor, the processor is configured to execute the computer-readable instructions stored in the memory, and when the computer-readable instructions are executed by the processor, the processor executes steps of an information feedback method in the first aspect or any optional implementation in the first aspect.

In the fourth aspect, embodiments of the present disclosure further provide a computer-readable storage medium, on which a computer program is stored. When the computer program is run, steps of an information feedback method in the first aspect or any optional implementation in the first aspect are executed.

### BRIEF DESCRIPTION OF DRAWINGS

To describe technical solutions of the embodiments of the present disclosure more clearly, the accompanying drawings required in the description of the embodiments will be described briefly below. The accompanying drawings, which are hereby incorporated in and constitute a part of the present description, illustrate the embodiments of the present disclosure, and together with the description, serve to explain the principles of the embodiments of the present disclosure. Apparently, the following drawings only illustrate some embodiments of the present disclosure and should not be regarded as limiting the scope of the present disclosure, other accompanying drawings can also be derived from these drawings by those ordinarily skilled in the art without creative efforts.

FIG. 1 is a flowchart of an information feedback method provided by embodiments of the present disclosure;

FIG. 2 is a schematic diagram showing response information when displaying target information provided by embodiments of the present disclosure;

FIG. 3 is a schematic diagram showing an interactive confirmation pop-up window provided by embodiments of the present disclosure;

FIG. 4 is a schematic diagram of an information feedback apparatus provided by embodiments of the present disclosure; and

FIG. 5 is a schematic diagram of a computer device provided by embodiments of the present disclosure.

### DETAILED DESCRIPTION

In order to make objectives, technical details, and advantages of the embodiments of the present disclosure clearer, the technical solutions of the embodiments will be described in a clearly and fully understandable way in connection with the drawings related to the embodiments of the present disclosure. Apparently, the described embodiments are just a part but not all of the embodiments of the present disclosure. The components of the disclosed embodiments described and illustrated in the accompanying drawings may be arranged and designed in various different configurations. Therefore, the detailed description of the embodiments of the present disclosure is not intended to limit the scope of the present disclosure, but only to represent the selected embodiments of the present disclosure. Based on the disclosed embodiments, all other embodiments obtained by those skilled in the art without creative labor fall within the protection scope of the present disclosure

Through research, it is found that in the scene of book reading, readers may have various reading needs, such as wanting to preview upcoming plot developments, review specific passages, or switch between audiobook mode and reading mode in reading process. In some instances, book reading platforms only provide reading tools, readers can only read books on the book reading platforms, when readers have specific reading requirements, they need to manually search through the books to access the content they are looking for, which is a cumbersome and inconvenient process.

Based on the above research, embodiments of the present disclosure provide an information feedback method. In the scene of reading a target book, when selecting to enable an information feedback function, the user voice data can be obtained, the user's operation intention towards the target book may be determined through the semantic analysis result of the user voice data, and target information satisfying the user's operation intention may be fed back to the user by using the book information of the target book. In this way, by providing a voice control function to the user in the book reading scene, the user can easily initiate a book-related request by sending a voice message, and a server may automatically analyze the user's reading requirements for the target book according to the received voice data, and organize and feed back the target information according to the book information of the target book, without the need for the user to manually search through the book or perform related operations, which is more convenient for the user.

The shortcomings of the above solutions are all the research results of the inventor(s) through practice and careful study. Therefore, the discovery process of the above problems and solutions proposed in the present disclosure with respect to the above problems in the following text should all be the contributions made by the inventor(s) to the present disclosure.

It should be noted that: similar reference signs and letters indicate similar items in the drawings below, and therefore once a certain item is defined in one drawing, it does not need to be further discussed in subsequent drawings.

For convenience of understanding this embodiment, firstly an information feedback method disclosed in the embodiments of the present disclosure is introduced in detail; an executing body of the information feedback method provided by the embodiments of the present disclosure is usually a computer device having certain computing function; the computer device, for example, includes: a terminal device, a server, or other processing device; the terminal device may be a user equipment (UE), a mobile device, a user terminal, a terminal, a cellular phone, a cordless phone, a personal digital assistant (PDA), a handheld device, a computing device, a vehicle-mounted device, a wearable device, etc. In some possible implementations, the information feedback method may be implemented by a processor calling computer readable instructions stored in a memory.

The information feedback method provided by the embodiments of the present disclosure will be described below. The information feedback method provided by the embodiments of the present disclosure is executed by a server, for example, a server installed on a user device or a platform. Specifically, the information feedback method may be applied to a platform that provides a book reading function, such as a reading applet or application software.

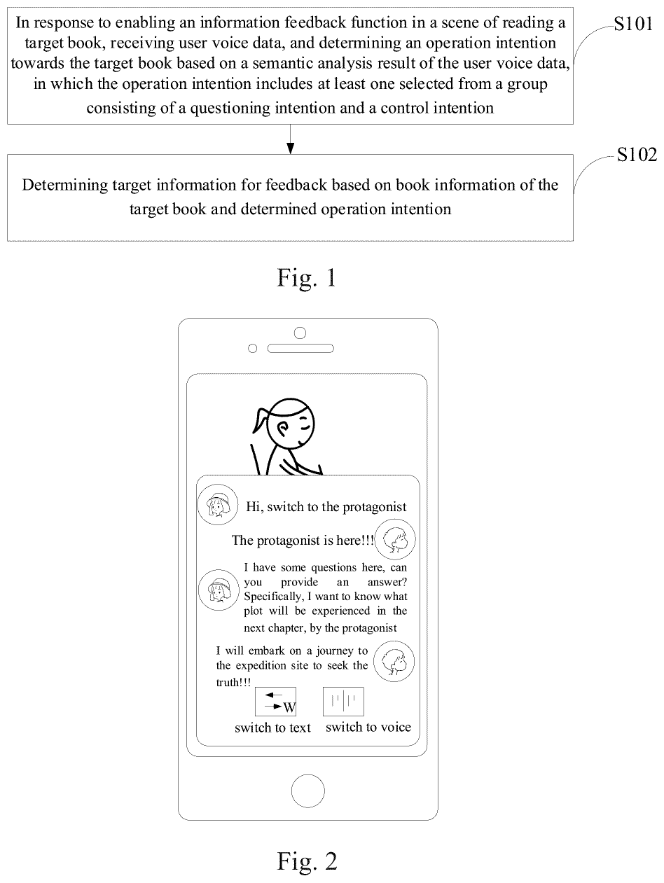

Referring to FIG. 1, which is a flowchart of an information feedback method provided by embodiments of the present disclosure, the method includes steps S101-S102 as below.

S101, in response to enabling an information feedback function in a scene of reading a target book, receiving user voice data, and determining an operation intention towards the target book based on a semantic analysis result of the user voice data, in which the operation intention includes at least one selected from a group consisting of a questioning intention and a control intention.

S102, determining target information for feedback based on book information of the target book and determined operation intention.

For S101 mentioned above, the scene of reading a target book will be explained first. In a book reading platform, a user can select a book to read. In the embodiments of the present disclosure, a book currently read by the user is considered as the target book. The corresponding scene of reading the target book is referred to as the scene of reading a target book. There are several different ways to read the target book on the reading platform, such as in the form of an e-book reading mode, or an audiobook mode, that is, an audio book reading mode. Thus, in the embodiments of the present disclosure, the scene of reading a target book may specifically be e-book reading scene, audiobook reading scene, and the like.

In the scene of reading the target book, the user may have various reading needs, such as wanting to preview upcoming plot developments or refer to specific passages. In order to meet users' reading needs, in the embodiments of the present disclosure, an information feedback function is specifically provided. After the information feedback function is enabled, user voice data may be received, and a specific operation intention of the user towards the target book under the reading needs may be analyzed. Therefore, for users, voice data expressing their reading needs may be sent through voice interaction. The voice data may include information such as “Go back to the previous chapter”, “Read the book in the voice of the protagonist”, “What will happen to the leading role in the next chapter”, and so on.

For the information feedback function, in one possible implementation, the information feedback function may be enabled continuously in the scene of reading the target book; or, in another possible implementation, a button for triggering the information feedback function may be displayed in a reading page of the target book, so that users can trigger the button to enable the information feedback function when having specific reading needs in the reading scene.

Semantic analysis may be conducted on the received user voice data to determine the operation intention towards the target book according to the obtained semantic analysis result. Here, the operation intention specifically includes at least one selected from the group consisting of a questioning intention and a control intention. For example, the voice data “Go back to the previous chapter” and “Read the book in the voice of the protagonist” in the above example specifically indicate operations on the target book, and the operation intention is the control intention; and the voice data “What will happen to the leading role in the next chapter” in the above example specifically instruct to summarize the content of the target book in order to provide a specific answer to the user, and in this case, the operation intention is the questioning intention.

For S102 mentioned above, since the operation intention determined in the above step are specific for controlling the operation on the target book, in response to the operation intention having been determined, it is possible to determine the target information for feedback based on the book information of the target book. For example, under the voice data in the above example, the target information for feedback may include reading content corresponding to the previous chapter of the current reading position of the target book, book content read after switching to the protagonist's voice packet, or a summary of the story of the leading role in the next chapter obtained by organizing the book information.

Below, the ways to determine the target information under different operation intentions are explained in detail.
(1) The operation intention towards the target book includes a questioning intention.

In this case, the target information for feedback may be specifically determined as follows: determining questioning information for the book information under the questioning intention; and determining response information under the questioning information based on the book information of the target book, as the target information for feedback.

Specifically, in response to determining that the operation intention is the questioning intention, the specific questioning information for the book information will be determined based on the user voice data and/or the semantic analysis result of the user voice data first, and then the target information for feedback will be determined based on the questioning information.

Here, the questioning information may be determined according to the user voice data and/or the semantic analysis result of the user voice data. For example, the user voice data includes “I have some questions here, can you provide an answer? Specifically, I want to know what plot will be experienced in the next chapter, by the protagonist”. Since users may have variations in semantic order when sending a voice message, for the user voice data in the example, the semantic analysis result may be used to first identify the inquiry portion “what plot will be experienced in the next chapter, by the protagonist”. This portion may then be refined and/or reconstructed in terms of language structure, like reorganizing it into “what plot will be experienced by the protagonist in the next chapter”. Since a trained model may be utilized to determine the target information for feedback, questioning information of more clear and precise semantics is beneficial for the model to determine the target information for feedback.

Specifically, the step of determining response information under the questioning information based on the book information of the target book may be performed by a trained model. In the embodiments of the present disclosure, a pre-trained model matching the target book may be determined, the pre-trained model is obtained by training based on the book information of the target book; and by taking the questioning information as input data of the pre-trained model, making the pre-trained model conduct processing based on the questioning information to obtain an output result, and determining the response information based on the output result.

Here, the pre-trained model may be a neural network model. Because the trained model is specifically used to reply to the questioning information which is aimed at the target book, the pre-trained model is trained based on the book information of the target book. In one possible implementation, the book information and information related to the target book such as summary content and comment information may be used as content information for training the pre-trained model. Here, the summary content includes, for example, roles, plots, chapter introductions, etc. The comment information may specifically include the creation background provided by the author of the target book, and evaluation content provided by book reviewers or readers, etc. The pre-trained model may analyze and organize the content information, to obtain a knowledge model for the target book.

Therefore, the questioning information may be used as the input data of the pre-trained model, so that the pre-trained model can analyze the questioning information to obtain the output result. For example, for the inquiry about chapter content in the above example, the pre-trained model may generate the output result “the protagonist embarks on a journey to the expedition site to seek the truth”. Here, the output result may be used to reply to the questioning information, and may also be further linguistically refined to better satisfy the current user's operational needs. For example, in the above example, since the user makes it clear in the voice message that he/she wants to know what the protagonist will experience in the next chapter, based on the user's questioning format, the output result may be changed to “the protagonist will experience the plot of embarking on a journey to the expedition site to seek the truth in the next chapter”.

Alternatively, in the embodiments of the present disclosure, it is also possible to accept questions of the user in the role of an assistant, a protagonist, etc., that is, simulate different roles such as an assistant or a protagonist through the expression characteristics of the response information. In this case, when determining the response information based on the output result, the expression characteristics of the response information may also be determined according to the selected role attributes, so as to obtain the response information under the expression characteristics. Based on the above example, when the protagonist's role is selected to accept the questions of the user, the answer information can be given in the protagonist's personal name, combined with the protagonist's language characteristics, etc., to obtain the answer information such as “I will embark on a journey to the expedition site to seek the truth!!!”.

Here, the determined response information will be displayed as the target information for feedback. For example, FIG. 2 is a schematic diagram showing response information under target information provided by embodiments of the present disclosure. In the scene of reading the target book, for example, in the audiobook reading scene, a dialogue pop-up window with the lower border aligned with the lower part of the page is displayed, or the dialogue pop-up window may be displayed in full screen or as a new page, this is just an example. In the dialogue pop-up window, for example, the left side shows the voice data sent by the user, and the right side shows the target information fed back according to the user voice data, that is, the response information. Here, both the voice data sent by the user and the target information fed back may be voice information, which may be converted into text to be displayed in the form of text information. An icon for voice and text conversion is displayed in a toolbar below the dialogue pop-up window, or may also be displayed alongside the related voice or text information to selectively convert display types for specific information. Only the identified text information is shown in FIG. 2.

As for the displayed target information, in one possible implementation, because the information content used in training the pre-trained model is limited, the output results of the pre-trained model may be inaccurate for some complicated questioning information identified, thus impacting the accuracy of the displayed response information.

In order to solve the above problems, the embodiments of the present disclosure also provide the step of correcting and collecting the response information to iteratively update the pre-trained model, to obtain more accurate response information in interactions with users thereafter.

In specific implementations, after displaying the response information as the target information, the method may further include the following steps a1-a3.

In a1, displaying an interactive confirmation pop-up window for the target information, in which the interactive confirmation pop-up window is used for receiving feedback on the target information.

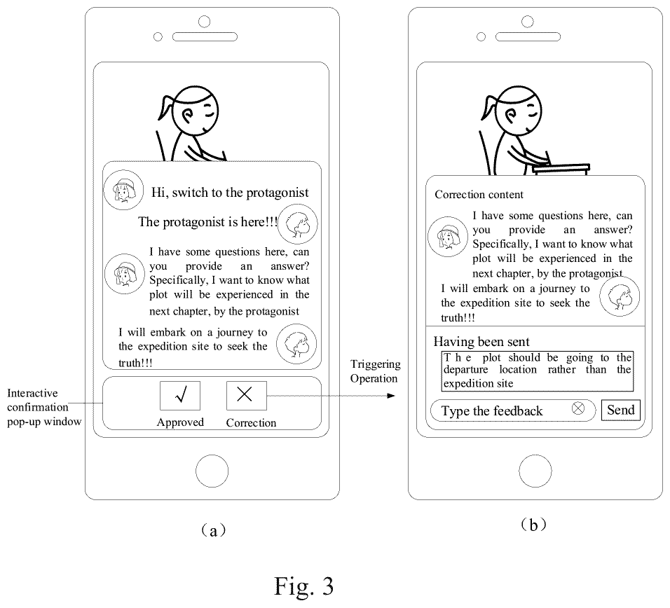

For example, FIG. 3 is a schematic diagram showing an interactive confirmation pop-up window provided by embodiments of the present disclosure. Because the response information may be correct or wrong, the interactive confirmation pop-up window includes confirmation buttons for both correct and wrong situations, such as two different confirmation buttons labeled “Correction” and “Approved” in the pop-up window shown in FIG. 3(a).

The “Approved” confirmation button indicates that the user has approved the target information after being triggered, so the feedback on the target information can be considered as approval, and no further correction is needed. The “Correction” confirmation button indicates that the user has doubts about the displayed target information after being triggered. In order to enable the user to give feedback or directly correct the problematic part, for example, a new pop-up window may be shown after the “Correction” confirmation button being triggered, offering users the option to provide feedback through voice input or keyboard input, such as the pop-up window shown in FIG. 3(b), and feedback may also be input by text typing, such as “Error in plot description” or corrections like “The plot should be going to the departure location rather than the expedition site”.

In a2, in response to the feedback indicating correction of the target information, acquiring a correction result for the target information, and determining the correction result and the corresponding questioning information as first tag data; or, in response to the feedback indicating approval of the target information, determining the target information and the corresponding questioning information as second tag data.

Here, when the feedback specifically includes correction information, for example, the correction information in the above example is “The plot should be going to the departure location rather than the expedition site”, the correction information may be used to correct the target information; for example, according to its semantic information, the “expedition site” in the target information “I will embark on a journey to the expedition site to seek the truth!!!” is changed to “departure location”, resulting in corrected target information “I will embark on a journey to the departure location to seek the truth!!!”. In this way, using the correction result and the corresponding questioning information, a piece of tag data confirmed to be correct is obtained.

When the feedback indicates approval of the target information, it means that the original target information is the correct result, and the obtained target information and the corresponding questioning information may be determined as the second tag data in a similar way.

In this way, the obtained first tag data and second tag data may be used as positive sample data for conducting supervised training on the pre-trained model.

In a3, iteratively updating the pre-trained model by using the first tag data or the second tag data.

In this step, because new tag data may be continuously generated in the above application scene, the pre-trained model may be continuously updated in the actual application process to continuously improve the accuracy of the target information obtained by the pre-trained model.
(2) The operation intention towards the target book includes a control intention.

In this case, the target information for feedback may be specifically determined as follows: determining an information type to be changed and a changed target state for the target book under the control intention; and determining display information of various information types under the target state, as the target information for feedback.

For example, the voice data such as “Go back to the previous chapter” and “Read the book in the voice of the protagonist” in the above example actually indicates a control intention towards the book, such as going to a specific chapter of the book or switching voice packages. Therefore, under the control intention, an information type to be changed may be determined, including, for example, showing different chapters, turning pages to different chapters or jumping to audio of different chapters, and also including switching between different role voice packages to read the book.

In addition, after determining the information type to be changed, a changed target state may be determined, such as a display state after switching the book reading page to a specific chapter or a voice after changing the audiobook to a different role's voice. With the target state determined, updates may be made to the display, such as jumping to display the text of a specific chapter on the book reading page, or playing the audiobook under the selected role's voice, and the like.

In this way, for the user, confirmation of the completion of the operational control on the target book may be achieved by updating the displayed target information.

In the above embodiments, the operation intention of the user is determined based on the voice information of the user, so as to provide the target information. In some possible implementations, in the book reading scene, users may simply activate the smart control function without sending voice data. In such cases, the user may have not yet organized specific questions to ask. Therefore, in the embodiments of the present disclosure, information that users may need is provided to enrich the information available to users.

In specific implementations, the method may include: determining an information feedback strategy, in which the information feedback strategy is determined based on a current reading progress of the target book and/or an information feedback record associated with book information indicated by the current reading progress; and determining reference content information under the information feedback strategy, to determine target information for feedback based on the reference content information, in which the reference content information includes the information feedback record, and/or target book information determined from the target book based on the current reading progress.

Here, the current reading progress specifically indicates which part of the book information is currently read in the target book. The information feedback record associated with book information indicated by the current reading progress specifically includes question and answer records generated by other users under the book information determined by the current reading progress.

Using the above information, the information feedback strategy may be determined, such as providing users with prompt information for the current plot, offering response information that most users have received in that plot, or presenting a summary of the book content that has been completed.

The three different information feedback strategies will be illustrated below. In response to determining the information feedback strategy of providing users with prompt information for the current plot, reference content information under the information feedback strategy may be determined, the reference content information includes the book information corresponding to the current reading chapter determined based on the current reading progress, and then based on the reference content information, the target information for feedback such as “You can ask, in this chapter, what is the ending of the protagonist in the cave?” is obtained.

In response to determining the information feedback strategy of offering response information that most users have received in that plot, reference content information under the information feedback strategy may be determined, the reference content information includes access-authorized information feedback record under the current reading chapter. For example, when several users inquire about the ending of the protagonist's story in this chapter and all approve the response information “Although the protagonist did not find the tomb, in the next chapter, he and the female lead discovered time-travel mechanism together”, then this response information may be determined as the target information fed back by the user.

In response to determining the information feedback strategy of presenting a summary of the book content that has been completed, reference content information under the information feedback strategy may be determined, the reference content information includes the target book information that has been completed in the target book, and a summary of the book that has been completed is provided as the target information, such as “The content you have read includes: the protagonist leads his companions to embark on an adventure from the departure location, but currently the protagonist has not found the tomb and is preparing for the next stage of exploration”.

Further, the above embodiments are specifically about information feedback in the scene of reading the target book, and such information feedback may also be applied to other possible scenarios under the reading platform, such as enabling the information feedback function even if reading of a specific book has not been initiated on the reading platform.

In a non-reading scene, the possible needs of users include but are not limited to continuing reading unfinished books or finding new books to read. Therefore, in this case, in response to enabling the information feedback function in the non-reading scene, it may be determined first that target books in the non-reading scene include recommended books and/or previously read books. Specifically, unlike the above embodiments, this embodiment is about the non-reading scene and does not involve a certain determined book, so books that may be the target books may be screened out first, such as recommended books that may be recommended to users for reading and previously read books that the users have read.

Then user voice data may be received, a target book for determining target information is screened out from a plurality of books based on a semantic analysis result of the user voice data, and target book information is selected from book information of the target book. The target information for feedback may be obtained based on the target book information.

Two specific examples are provided below for detailed illustration.

In a possible example, the user voice data includes, for example, “Has book A been updated?”. In this case, the determined target book is book A. The target book information selected from the book information of the target book may specifically include the user's historical reading record for this book, and may also include the update record of the target book, so as to obtain the target information for feedback. For example, the historical reading record indicates that the current user has read up to the third chapter of the target book, and the latest update is the fifth chapter, so the obtained target information for feedback may be “Book A has been updated by two chapters, and recently is updated to the fifth chapter”.

In this way, by asking questions, users can quickly obtain the update information of the specific book, aiding in their decision on whether to continue reading the book and helping them select a book for reading.

In another possible example, books may be recommended to users, and the received user voice data is, for example, “Recommend a new book”. In this case, the screened-out target books include, for example, the recommended books and the previously read books, and the target book information includes book types of the recommended books, book types of the previously read books and access-authorized reading records.

Here, the determined recommended books are used to recommend new books to users, and the determined previously read books are specifically used to determine what types of books are suitable for recommending to users. In specific implementations, based on the access-authorized reading records corresponding to the previously read books, target previously read books with corresponding reading records meeting a screening condition are screened out from the previously read books; and a target book type is determined based on book types corresponding to the target previously read books. For example, in response to determining that the previously read books of the user include romance type and adventure type, and that the user rarely reads books of romance type based on the access-authorized reading records, the adventure type may be selected as the target book type for recommendations.

Then, a target recommended book of the adventure type may be selected from the recommended books. After determining the book information corresponding to the target recommended book, the target information for feedback may be determined, such as “Recommendation: Read book B”, or book recommendation reasons may be further provided in the target information, like updating the information to “Recommendation: Read book B, this is a novel of adventure type, and 80% of users who have read book A chose to read it”.

In this way, books may be intelligently recommended to users to solve the problem of users having difficulty in choosing a book to read.

In addition, in the above scene, the embodiments of the present disclosure may specifically provide auxiliary functions such as scheduled audiobook playback. For example, in response to the received user voice data indicating that the user wants to read a book at specific time, such as every day at 8 μm or when a new chapter is available, proactively feeding back the user with prompt information to read the book at the scheduled time or when there is the update.

For the target information fed back described in the above example, selected content may also be packaged and shared in response to a forwarding operation by the user, for example, shared with other users or displayed under topics of the book.

Based on the description of the above embodiments, the information feedback method provided by the embodiments of the present disclosure can be applied to both reading scene and non-reading scene, and feedback can be provided according to the received user voice data or information can be proactively provided in different scenes. Functions that can be realized include, but are not limited to, controlling books and answering specific questions about books. Therefore, the information feedback method provided by the embodiments of the present disclosure can specifically meet the different needs of users in various scenes in the reading platform.

It can be understood by those skilled in the art that in the above-mentioned method according to specific implementations, the order of the steps does not necessarily imply a strict execution sequence or impose any limitations on the implementation process. The specific execution sequence of each step should be determined based on its functionality and possible inherent logic.

Based on the same inventive concept, embodiments of the present disclosure further provide an information feedback apparatus corresponding to the information feedback method. Since the principle of solving problems by the apparatus in the embodiments of the present disclosure is similar to the above-mentioned information feedback method, the implementation of the method can be used as a reference for the implementation of the apparatus, which will not be repeated here.

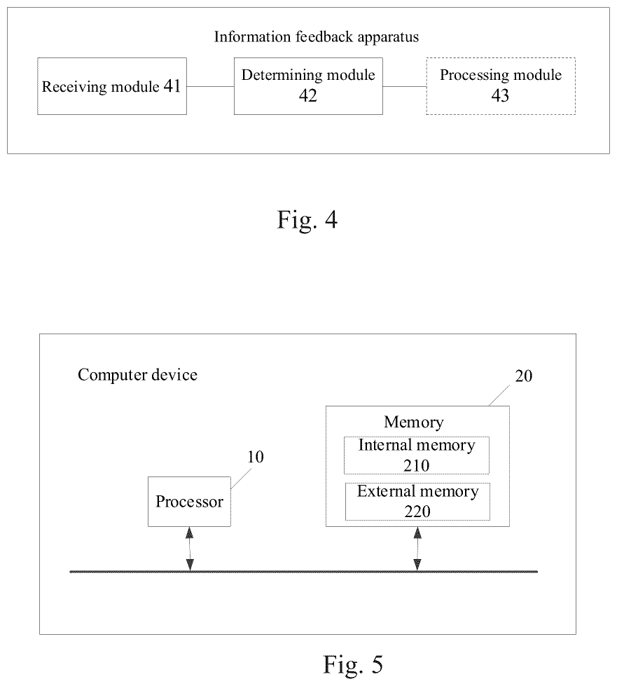

Referring to FIG. 4, which is a schematic diagram of an information feedback apparatus provided by embodiments of the present disclosure, the apparatus includes: a receiving module 41 and a determining module 42.

The receiving module 41 is configured to, in response to enabling an information feedback function in a scene of reading a target book, receiving user voice data, and determining an operation intention towards the target book based on a semantic analysis result of the user voice data, in which the operation intention includes at least one selected from a group consisting of a questioning intention and a control intention.

The determining module 42 is configured to determine target information for feedback based on book information of the target book and determined operation intention.

In an optional implementation, in response to the operation intention towards the target book including the questioning intention, when the determining module 42 is configured to determine target information for feedback based on book information of the target book and determined operation intention, the determining module 42 is specifically configured to determine questioning information for the book information under the questioning intention; and determine response information under the questioning information based on the book information of the target book, as the target information for feedback.

In an optional implementation, when the determining module 42 is configured to determine response information under the questioning information based on the book information of the target book, the determining module 42 is specifically configured to determine a pre-trained model matching the target book, in which the pre-trained model is obtained by training based on the book information of the target book; and take the questioning information as input data of the pre-trained model, make the pre-trained model conduct processing based on the questioning information to obtain an output result, and determine the response information based on the output result.

In an optional implementation, after displaying the response information as the target information, the determining module 42 is further configured to display an interactive confirmation pop-up window for the target information, in which the interactive confirmation pop-up window is used for receiving feedback on the target information; in response to the feedback indicating correction of the target information, acquire a correction result for the target information, and determine the correction result and corresponding questioning information as first tag data; or, in response to the feedback indicating approval of the target information, determine the target information and corresponding questioning information as second tag data; and iteratively update the pre-trained model by using the first tag data or the second tag data.

In an optional implementation, in response to the operation intention towards the target book including the control intention, when the determining module 42 is configured to determine target information for feedback based on book information of the target book and determined operation intention, the determining module 42 is specifically configured to determine an information type to be changed and a changed target state for the target book under the control intention; and determine display information of various information types under the target state, as the target information for feedback.

In an optional implementation, in response to enabling the information feedback function in the scene of reading the target book, the receiving module 41 is further configured to determine an information feedback strategy, in which the information feedback strategy is determined based on a current reading progress of the target book and/or an information feedback record associated with book information indicated by the current reading progress; and determine reference content information under the information feedback strategy, to determine target information for feedback based on the reference content information, in which the reference content information includes the information feedback record, and/or target book information determined from the target book based on the current reading progress.

In an optional implementation, the apparatus further includes a processing module 43, the processing module 43 is configured to, in response to enabling the information feedback function in a non-reading scene, determine that target books in the non-reading scene comprise recommended books and/or previously read books; receive user voice data, screening out a target book for determining target information from a plurality of books based on a semantic analysis result of the user voice data, and select target book information from book information of the target book; and organize the target book information to obtain the target information for feedback.

In an optional implementation, in response to the semantic analysis result indicating book recommendation, the screened-out target book includes the recommended books and the previously read books, and the target book information comprises book types of the recommended books, book types of the previously read books and access-authorized reading records; and when the processing module 43 is configured to organize the target book information to obtain the target information for feedback, the processing module 43 is specifically configured to, based on the access-authorized reading records corresponding to the previously read books, screen out target previously read books with corresponding reading records meeting a screening condition from the previously read books; determine a target book type based on book types corresponding to the target previously read books; and select a target recommended book with the target book type from the recommended books, and determine the target information for feedback based on book information corresponding to the target recommended book.

The descriptions of the processing flow of each module in the apparatus and the interaction flow between each module can refer to the relevant illustrations in the above method implementation examples, which will not be elaborated here.

Embodiments of the present disclosure further provide a computer device. Referring to FIG. 5, which is a structural schematic diagram of a computer device provided by embodiments of the present disclosure, the computer device includes a processor 10 and a memory 20. The memory 20 stores computer-readable instructions executable by the processor 10, the processor 10 is used for executing the computer-readable instructions stored in the memory 20, and when the computer-readable instructions are executed by the processor 10, the processor 10 executes the following steps:
in response to enabling an information feedback function in a scene of reading a target book, receiving user voice data, and determining an operation intention towards the target book based on a semantic analysis result of the user voice data, in which the operation intention includes at least one selected from a group consisting of a questioning intention and a control intention; and determining target information for feedback based on book information of the target book and determined operation intention.

The memory 20 includes an internal memory 210 and an external memory 220. Here, the internal memory 210, also called the internal storage, is used for temporarily storing operation data in the processor 10 and data exchanged with the external memory 220 such as a hard disk. The processor 10 exchanges data with the external memory 220 through the internal memory 210.

For the specific execution process of the above instructions, the steps of the information feedback method described in the embodiments of the present disclosure may be used for reference, which will not be repeated here.

Embodiments of the present disclosure further provide a computer-readable storage medium, on which a computer program is stored. The computer program, when run by the processor, executes the information feedback method described in the above method embodiments. The storage medium may be a transitory or non-transitory computer-readable storage medium.

Embodiments of the present disclosure further provide a computer program product, the computer program product carries a program code, which includes instructions that can be used to execute the steps of the information feedback method described in the above method embodiments. Please refer to the above method embodiments for details, which is not be repeated here.

The computer program product can be specifically implemented through hardware, software, or a combination thereof. In one optional embodiment, the computer program product is specifically implemented as a computer storage medium, while in another optional embodiment, the computer program product is specifically implemented as a software product, such as a software development kit (SDK), etc.

Those skilled in the field can clearly understand that for the convenience and conciseness of description, the specific working process of the system and device described above can refer to the corresponding process in the aforementioned method embodiments, and will not be repeated here. In several embodiments provided in the present disclosure, it should be understood that the disclosed apparatus, device, and method may be implemented in other ways. The device embodiments described above are only illustrative. For example, the division of the modules is only a logical function division, and there may be other division methods in actual implementation. For example, multiple modules or components can be combined or integrated into another system, or some features can be ignored or not executed. In addition, the coupling or direct coupling or communication connection shown or described can be indirect coupling or communication connection through some communication interfaces, devices or modules, which can be electrical, mechanical or in other forms.

The modules described as separate components may be or not be physically separated, and the components shown as modules may be or not be physical modules, that is, they can be located in one place or distributed in multiple network modules. Some or all modules can be selected according to actual needs to achieve the purpose of the embodiments.

In addition, in various embodiments of the present disclosure, each functional module may be integrated into one processing module, or each module may physically exist separately, or two or more modules may be integrated into one module.

When the functions are implemented in the form of software functional modules and sold or used as independent products, they can be stored in a non-transitory computer-readable storage medium that can be executed by a processor. Based on this understanding, at least part of the technical solutions of the present disclosure can be in the form of a software product. The computer software product is stored in a storage medium and includes several instructions to enable a computer device (which can be a personal computer, server, or network device, etc.) to perform all or part of the steps of the methods described in the various embodiments of the present disclosure. The storage medium includes: a USB flash drive, a portable hard drive, a read only memory (ROM), a random access memory (RAM), a disk, a CD, or other media that can store program code.

Finally, it should be noted that the above embodiments are only specific implementations of the present disclosure, used to illustrate the technical solutions of the present disclosure, and not to limit the present disclosure. The protection scope of the present disclosure is not limited to this. Although detailed explanations of the present disclosure have been made with reference to the aforementioned embodiments, ordinary technical personnel in the art should understand that any technical personnel familiar with the art can still modify or easily think of changes to the technical solutions recorded in the aforementioned embodiments within the scope of the disclosed technology, or replace some of the technical features equally; and these modifications, changes, or replacements are all within the spirit and scope of the technical solutions of the present disclosure, and should be covered within the protection scope of the present disclosure. Therefore, the protection scope of the present disclosure should be based on the claims.

1. An information feedback method, comprising:
in response to enabling an information feedback function in a scene of reading a target book, receiving user voice data, and determining an operation intention towards the target book based on a semantic analysis result of the user voice data, wherein the operation intention comprises at least one selected from a group consisting of a questioning intention and a control intention; and
determining target information for feedback based on book information of the target book and determined operation intention.

2. The method according to claim 1, wherein in response to the operation intention towards the target book comprising the questioning intention, the determining target information for feedback based on book information of the target book and determined operation intention comprises:
determining questioning information for the book information under the questioning intention; and
determining response information under the questioning information based on the book information of the target book, as the target information for feedback.

3. The method according to claim 2, wherein the determining response information under the questioning information based on the book information of the target book comprises:
determining a pre-trained model matching the target book, wherein the pre-trained model is obtained by training based on the book information of the target book; and
taking the questioning information as input data of the pre-trained model, making the pre-trained model conduct processing based on the questioning information to obtain an output result, and determining the response information based on the output result.

4. The method according to claim 3, after displaying the response information as the target information, further comprising:
displaying an interactive confirmation pop-up window for the target information, wherein the interactive confirmation pop-up window is used for receiving feedback on the target information;
in response to the feedback indicating correction of the target information, acquiring a correction result for the target information, and determining the correction result and corresponding questioning information as first tag data; or, in response to the feedback indicating approval of the target information, determining the target information and corresponding questioning information as second tag data; and
iteratively updating the pre-trained model by using the first tag data or the second tag data.

5. The method according to claim 1, wherein in response to the operation intention towards the target book comprising the control intention, the determining target information for feedback based on book information of the target book and determined operation intention comprises:
determining an information type to be changed and a changed target state for the target book under the control intention; and
determining display information of various information types under the target state, as the target information for feedback.

6. The method according to claim 1, wherein in response to enabling the information feedback function in the scene of reading the target book, the method further comprises:
determining an information feedback strategy, wherein the information feedback strategy is determined based on a current reading progress of the target book and/or an information feedback record associated with book information indicated by the current reading progress; and
determining reference content information under the information feedback strategy, to determine target information for feedback based on the reference content information, wherein the reference content information comprises the information feedback record, and/or target book information determined from the target book based on the current reading progress.

7. The method according to claim 1, further comprising:
in response to enabling the information feedback function in a non-reading scene, determining that target books in the non-reading scene comprise recommended books and/or previously read books;
receiving user voice data, screening out a target book for determining target information from a plurality of books based on a semantic analysis result of the user voice data, and selecting target book information from book information of the target book; and
organizing the target book information to obtain the target information for feedback.

8. The method according to claim 7, wherein in response to the semantic analysis result indicating book recommendation, the screened-out target book comprises the recommended books and the previously read books, and the target book information comprises book types of the recommended books, book types of the previously read books and access-authorized reading records; and
organizing the target book information to obtain the target information for feedback comprises:
based on the access-authorized reading records corresponding to the previously read books, screening out target previously read books with corresponding reading records meeting a screening condition from the previously read books;
determining a target book type based on book types corresponding to the target previously read books; and
selecting a target recommended book with the target book type from the recommended books, and determining the target information for feedback based on book information corresponding to the target recommended book.

9. A computer device, comprising a processor and a memory, wherein the memory stores computer-readable instructions executable by the processor, the processor is configured to execute the computer-readable instructions stored in the memory, and when the computer-readable instructions are executed by the processor, the processor executes steps of an information feedback method, the method comprises:
in response to enabling an information feedback function in a scene of reading a target book, receiving user voice data, and determining an operation intention towards the target book based on a semantic analysis result of the user voice data, wherein the operation intention comprises at least one selected from a group consisting of a questioning intention and a control intention; and
determining target information for feedback based on book information of the target book and determined operation intention.

10. The computer device according to claim 9, wherein in response to the operation intention towards the target book comprising the questioning intention, the determining target information for feedback based on book information of the target book and determined operation intention comprises:
determining questioning information for the book information under the questioning intention; and
determining response information under the questioning information based on the book information of the target book, as the target information for feedback.

11. The computer device according to claim 10, wherein the determining response information under the questioning information based on the book information of the target book comprises:
determining a pre-trained model matching the target book, wherein the pre-trained model is obtained by training based on the book information of the target book; and
taking the questioning information as input data of the pre-trained model, making the pre-trained model conduct processing based on the questioning information to obtain an output result, and determining the response information based on the output result.

12. The computer device according to claim 11, after displaying the response information as the target information, further comprising:
displaying an interactive confirmation pop-up window for the target information, wherein the interactive confirmation pop-up window is used for receiving feedback on the target information;
in response to the feedback indicating correction of the target information, acquiring a correction result for the target information, and determining the correction result and corresponding questioning information as first tag data; or, in response to the feedback indicating approval of the target information, determining the target information and corresponding questioning information as second tag data; and
iteratively updating the pre-trained model by using the first tag data or the second tag data.

13. The computer device according to claim 9, wherein in response to the operation intention towards the target book comprising the control intention, the determining target information for feedback based on book information of the target book and determined operation intention comprises:
determining an information type to be changed and a changed target state for the target book under the control intention; and
determining display information of various information types under the target state, as the target information for feedback.

14. The computer device according to claim 9, wherein in response to enabling the information feedback function in the scene of reading the target book, the method further comprises:
determining an information feedback strategy, wherein the information feedback strategy is determined based on a current reading progress of the target book and/or an information feedback record associated with book information indicated by the current reading progress; and
determining reference content information under the information feedback strategy, to determine target information for feedback based on the reference content information, wherein the reference content information comprises the information feedback record, and/or target book information determined from the target book based on the current reading progress.

15. The computer device according to claim 9, further comprising:
in response to enabling the information feedback function in a non-reading scene, determining that target books in the non-reading scene comprise recommended books and/or previously read books;
receiving user voice data, screening out a target book for determining target information from a plurality of books based on a semantic analysis result of the user voice data, and selecting target book information from book information of the target book; and
organizing the target book information to obtain the target information for feedback.

16. The computer device according to claim 15, wherein in response to the semantic analysis result indicating book recommendation, the screened-out target book comprises the recommended books and the previously read books, and the target book information comprises book types of the recommended books, book types of the previously read books and access-authorized reading records; and
organizing the target book information to obtain the target information for feedback comprises:
based on the access-authorized reading records corresponding to the previously read books, screening out target previously read books with corresponding reading records meeting a screening condition from the previously read books;
determining a target book type based on book types corresponding to the target previously read books; and
selecting a target recommended book with the target book type from the recommended books, and determining the target information for feedback based on book information corresponding to the target recommended book.

17. A computer-readable storage medium, wherein a computer program is stored on the computer-readable storage medium, and when the computer program is run on a computer device, the computer device executes steps of an information feedback method, the method comprises:
in response to enabling an information feedback function in a scene of reading a target book, receiving user voice data, and determining an operation intention towards the target book based on a semantic analysis result of the user voice data, wherein the operation intention comprises at least one selected from a group consisting of a questioning intention and a control intention; and
determining target information for feedback based on book information of the target book and determined operation intention.
